(19) United States
(12) Patent Application Publication
(10) Pub. No.: US 2024/0409203 A1
(43) Pub. Date: Dec. 12, 2024

(54) Hybrid Flight Control System

(71) Applicant: Textron Aviation Inc., Wichita, KS (US)

(72) Inventors: Stephen M. Eddy, Derby, KS (US); Steven G. Hagerott, Wichita, KS (US)

(21) Appl. No.: 18/737,093

(22) Filed: Jun. 7, 2024

Related U.S. Application Data
(60) Provisional application No. 63/506,821, filed on Jun. 7, 2023.
(60) Provisional application No. 63/506,822, filed on Jun. 7, 2023.

(51) Int. Cl. B64C 13/50; B64C 13/04

(52) U.S. Cl. CPC B64C 13/507; B64C 13/042

(57) ABSTRACT

A hybrid flight control system includes an operator input device having a force sensor and/or a position sensor. The operator input is connected to a first portion of the control surface via a mechanical linkage. The system includes an electro-mechanical actuator and an electro-mechanical actuator control system in data communication with the electro-mechanical actuator, as well as a flight control computing system in data communication with the operator input device and the electro-mechanical actuator control system. Upon receiving an input from an operator, the operator input device sends a signal to the flight control computing system. Upon receiving a signal from the operator input device, the flight control computing system sends a signal to the electro-mechanical actuator control system. Upon receiving a signal from the electro-mechanical actuator control system, the electro-mechanical actuator moves a second portion of the control surface according to a predetermined set of conditions.

### CROSS-REFERENCE TO RELATED APPLICATIONS

This application claims priority to U.S. Provisional Patent Application No. 63/506,821, filed on Jun. 7, 2023, and U.S. Provisional Patent Application No. 63/506,822, filed on Jun. 7, 2023, the disclosures of which are incorporated herein in their entirety by reference.

### BACKGROUND

### 1. Field

The disclosure relates generally to the field of aviation control systems. More specifically, the disclosure relates to systems and methods for manipulating control surfaces on an aircraft using hybrid methods to aerodynamically control flight characteristics.

### 2. Related Art

Various solutions have been proposed for augmenting an operator's input to improve the control of an aircraft. For example, U.S. Pat. No. 7,840,316 to Yount discloses FBW systems using computers to command actuators controlling flight surfaces. U.S. Pat. No. 9,415,860 to Beaufrere discloses a FBW system using electronic actuators and a force-transduced side stick. U.S. Pat. No. 5,456,428 to Hegg discloses a FBW system in which two or more side sticks are linked. U.S. Patent Application Publication No. 2021/197,958 to Liscouet discloses using electric motors to provide a resistant force to side sticks in order to replicate a mechanical feel in a FBW architecture.

### SUMMARY

The following presents a simplified summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

According to an embodiment, a hybrid flight control system includes an operator input device having a force sensor and/or a position sensor. The operator input is connected to a first portion of the control surface via a mechanical linkage. The system includes an electro-mechanical actuator and an electro-mechanical actuator control system in data communication with the electro-mechanical actuator, as well as a flight control computing system in data communication with the operator input and the electro-mechanical actuator control system. Upon receiving an input from an operator, the operator input device sends a signal to the flight control computing system. Upon receiving a signal from the operator inputs, the flight control computing system sends a signal to the electro-mechanical actuator control system. Upon receiving a signal from the electro-mechanical actuator control system, the electro-mechanical actuator moves a second portion of the control surface according to a predetermined set of conditions.

According to another embodiment, a hybrid flight control system for an aircraft having a control surface includes an operator input device connected to a first portion of the control surface via a mechanical linkage. The system includes an electro-mechanical actuator and an electro-mechanical actuator control system in data communication with the electro-mechanical actuator. The system also includes an air data computing system in data communication with the electro-mechanical actuator control system, wherein the air data computing system sends a signal to the electro-mechanical actuator control system. Upon receiving a signal from the electro-mechanical actuator control system, the electro-mechanical actuator adjusts a force reversing system to reduce the surface force reacted to the pilot according to a predetermined set of conditions.

According to yet another embodiment, a hybrid flight control system for an aircraft having a plurality of control surfaces includes an operator input configured to receive mechanical inputs from an aircraft operator, the operator means being connected to a sensor. The system includes a flight control computing system comprising a first and a second flight control computer, with each flight control computer being in data communication with the sensor, wherein the computing system receives a signal from at least one sensor in response to an input by the operator. The flight control system also includes a first control surface for controlling a first axis of the aircraft, with the first control surface having a first portion connected to the operator input via a mechanical linkage and a second portion connected to and moveable by at least one EMA in data communication with a first EMA controller configured to receive signals from the flight control computing system. The flight control system further includes a second control surface for controlling a second axis of the aircraft, the second control surface having a first portion connected to the operator input via a mechanical linkage and a second portion connected to and moveable by at least one EMA in data communication with a second EMA controller configured to receive signals from the flight control computing system.

### BRIEF DESCRIPTION OF THE DRAWING FIGURES

Illustrative embodiments of the present disclosure are described in detail below with reference to the attached drawing figures, wherein:

FIG. 1 illustrates a schematic view of an embodiment of a hybrid flight control system having mechanical side sticks with adjustable force reversers;

FIG. 2 illustrates a schematic view of an embodiment of a hybrid flight control system having torque motors which assist the operation of control surfaces;

FIG. 3 illustrates a schematic view of an embodiment of a hybrid flight control system having servos which assist the operation of control surfaces;

FIG. 4 illustrates a schematic view of another embodiment of a hybrid flight control system having servos and electro-mechanical actuators which operate aircraft control surfaces;

FIG. 5 illustrates a schematic view of an embodiment of a hybrid flight control system having electro-mechanical actuators which operate control surfaces;

FIG. 6 illustrates a schematic view of another embodiment of a hybrid flight control system having electro-mechanical actuators, which has additional control surfaces compared to the embodiment shown in FIG. 5; and

FIG. 7 illustrates a schematic view of another embodiment of a hybrid flight control system having electro-mechanical actuators and torque motors which operate control surfaces.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

Typically, the flight characteristics of an aircraft are controlled by a number of moveable aerodynamic surfaces on the wing and tail of the aircraft which can be manipulated to control the desired pitch, roll, and yaw. Smaller aircraft may use simple mechanical linkages to transmit a pilot's control inputs to these aerodynamic surfaces, while larger and/or faster aircraft may use power-assisted or fully-powered control systems. These powered control systems may use mechanical linkages as well as “fly-by-wire” (FBW) systems, which utilize a computerized command and a feedback loop. The FBW systems may be used in conjunction with the mechanical linkages, or some control systems may use FBW systems instead of mechanical linkages for certain elements.

Augmenting mechanical systems with fly-by-wire systems and/or other assistance systems may provide numerous advantages. While manually operated or fully mechanical control systems may provide a direct and reliable link between the operator's inputs and the subsequent behavior of the control surfaces, manual systems have limitations in functionality, force output, friction, and overall system deflection and compliance. With manual systems, the work available at the control surface(s) is directly related to (and therefore limited by) the force and/or travel that an operator can apply to the cockpit controls. As the speed and size of the aircraft increases, it can become increasingly difficult for a pilot to effectively control the aircraft, since the required force to activate the control surfaces also increases. It therefore may be advantageous for a control system to provide additional assistance or “boost” to the operator's input to achieve the desired flight characteristics. In the following description, flight control systems utilizing additional assistance to “boost” an operator's input may be interchangeably referred to as a boosted flight control system or a hybrid flight control system.

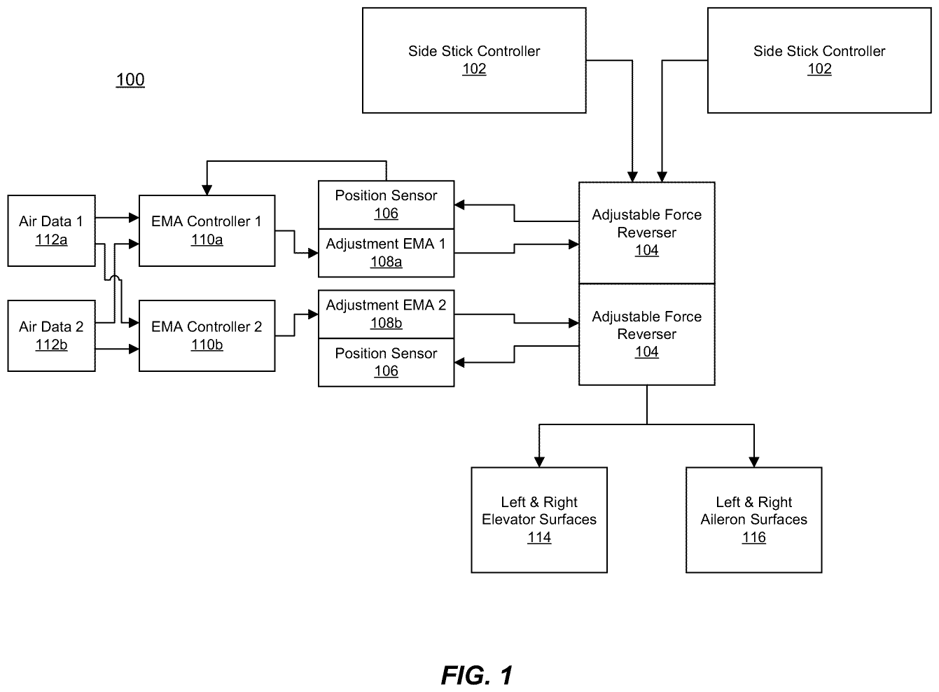

FIG. 1 shows a schematic layout of a first embodiment of a hybrid flight control system 100. The flight control system 100 uses one or more operator control devices (such as side stick controllers 102) connected to one or more adjustable force reversers 104 to control the aerodynamic control surfaces such as left and right elevators 114 and left and right ailerons 116. The adjustable force reversers may utilize a spring mechanism similar to that disclosed in U.S. Pat. No. 9,193,439 to Hagerott et al., the disclosure of which is incorporated herein, in its entirety, by reference. The adjustable force reverser(s) 104 alter the force required from the operator or pilot to actuate the aerodynamic control surfaces 114 and 116.

Each force reverser 104 is in connection with a position sensor 106, which monitors the position of the side stick controller 102. This position sensor 106 is in communication with a computer control system or electro-mechanical actuator (EMA) controller 110a or 110b. Each EMA controller 110a and 110b receives air data from an air data source 112a or 112b, respectively, which may be an air data computer (ADC). The air data is used to schedule the position of various EMAs, such as EMAs 108a and 108b. Each ADC 112a and 112b is cross-compared within each EMA controller 110 and 110b. Comparing the ADC data may allow the EMA controller or other computing system to identify any system failures, or may alternatively improve accuracy of the EMA control.

Each EMA controller 110a and 110b is connected to a respective EMA 108a or 108b. Each EMA is then connected to an adjustable force reverser 104, allowing for dynamic modulation of the spring force, which may reduce the hinge moment at the side stick controller 102. In some embodiments, the EMA 108a or 108b may adjust the force reverser 104 to produce a smooth force curve at the side sticks 102 with force that increases with dynamic pressure experienced by the control surfaces 114 and 116. In some embodiments, the force reversers 104 may be configured such that they provide no reversing until the surface hinge moments are sufficiently high enough to prevent the control surface 114 or 116 from being driven off-center. Therefore, in some applications, the force reversers 104 may not provide any force augmentation when not necessary.

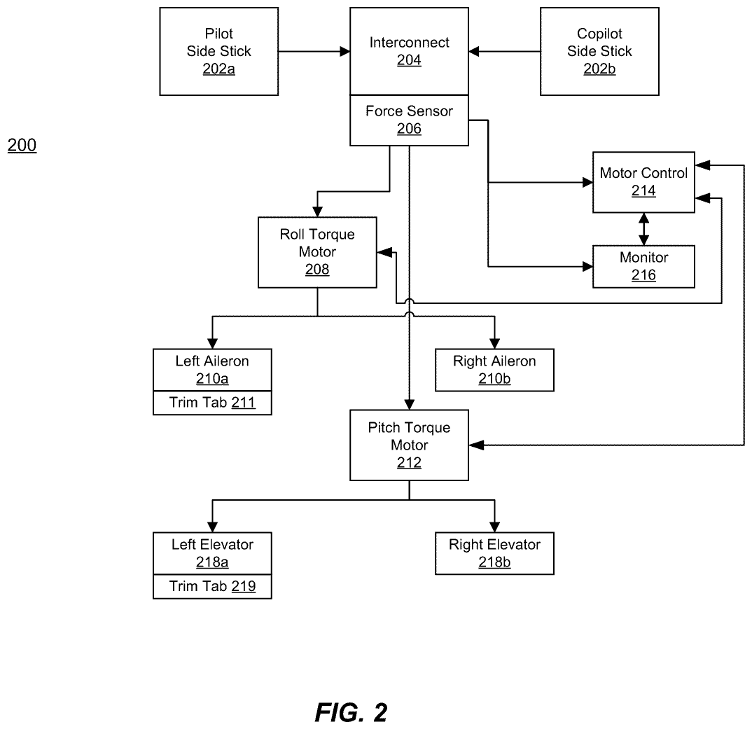

Referring now to FIG. 2, FIG. 2 shows a schematic layout of another embodiment of a hybrid flight control system 200. Flight control system 200 is similar to flight control system 100, however the flight control system 200 does not include any additional FBW augmentations such as adjustable EMAs or force reversers. Compared to flight control system 100, system 200 uses torque motors actively scheduled on pilot input force instead of passive spring force scheduled on aircraft air data to reduce control surface hinge moments. The pilot and copilot side sticks 202a and 202b are connected via an interconnect device 204 and are subsequently connected to or include a force sensor 206. The force sensor 206 may be connected to both a roll torque motor 208 and a pitch torque motor 212, as well as being in communication with a motor control system 214 and a monitoring system 216.

The embodiment shown in FIG. 2 provides assistance in series with the primary mechanical control path, wherein the operator input and the torque motors 208 and 212 work in tandem to operate the control surfaces. The roll torque motor 208 and the pitch torque motor 212 serve to amplify or “boost” the operator input by reducing the surface hinge moment feedback to the operator sufficiently to allow for comfortable control forces experienced or required by the operator. The roll torque motor may provide this force amplification for operation of the left aileron 210a and right aileron 210b. Some control surfaces such as trim tab 211 may be traditionally (i.e., purely mechanically or electrically) operated. The pitch torque motor 212 may provide the force amplification to the left and right elevators 218a and 218b, respectively, as well as trim tab 219. In the event of a single component failure, the flight control system 200 may revert to unassisted mechanical control.

The roll torque motor 208 and the pitch torque motor 212 are each connected to a motor control system 214, which is in communication with a monitor 216. The connection between each motor, the motor control system 214, and the force sensor 206 may form a feedback loop or “boost control loop” within the flight control system 200. In some embodiments, the boost control loop may operate at high frequencies, such as between 10 kHz and 20 kHz, for example, which may prevent any feedback coupling on the series path. In this system, the “boost” torque motors 208 and 212 follow the input from the pilot or copilot side sticks 202a and 202b to the control surfaces 210a, 210b, 211, 218a, 218b, and 219.

In some embodiments, the flight control system 200 may include one or more autopilot servos 220 and 222, which may operate the control surfaces described above. These autopilot servos 220 and 222 may be connected to the force sensor 206, and/or may form part of the feedback loop including the torque motors 208 and 212, the motor control system 214, and the monitor 216. In some embodiments, the torque motors 208 and 212 may operate as autopilot servos.

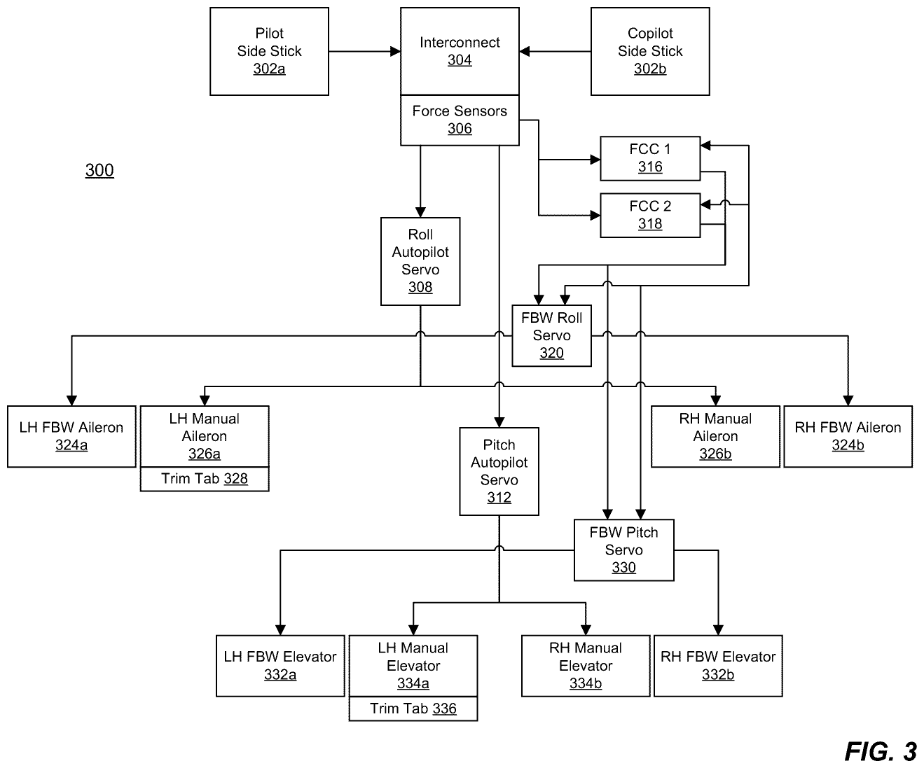

FIG. 3 shows another embodiment of a hybrid flight control system 300. The flight control system 300 comprises at least one control surface, and preferably multiple control surfaces. In some embodiments, these control surfaces—such as ailerons, roll spoilers, elevators, rudders, etc.—may include split surfaces, whereby some portions of the control surface are mechanically-controlled, and other portions of the control surface are controlled using fly-by-wire systems. Each control surface may be controlled (mechanically or using FBW) by one or more operator inputs, for example side sticks 302a and 302b.

Similar to flight control system 200, the hybrid flight control system 300 includes pilot and copilot side sticks 302a and 302b connected via an interconnect device 304 and are subsequently connected to or include a force sensor 306. The force sensor 306 is connected to and in data communication with a flight control computer system (FCC) 316, and preferably connected to and in data communication with at least a second FCC 318 which can provide redundancy in the event of a malfunction in FCC 316 or other elements of the flight control system 300.

In some embodiments, the roll control surfaces—ailerons and/or roll spoilers, for example—may include a fly-by-wire portion, such as left-hand and right-hand FBW ailerons 324a and 324b, respectively, as well as a manual or mechanical portion such as left-hand and right-hand manual ailerons 326a and 326b, respectively. The fly-by-wire ailerons 324a and 324b are connected to and in data communication with the first and second FCCs 316 and 318, and are operable using roll servo 320 in response to a signal from the operator inputs and/or force sensors 306 via the FCCs to vary the roll of the aircraft. The manual ailerons 326a and 326b may be selectively operable by an autopilot servo 308 which may command these control surfaces when autopilot is engaged. Some embodiments may also include an optional trim tab 328 disposed on at least one of the ailerons 326a and 326b.

Similarly, the pitch control may be split into a fly-by-wire portion, such as left-hand and right-hand FBW elevators 332a and 332b, respectively, as well as a manual or mechanical portion such as left-hand and right-hand manual elevators 334a and 334b, respectively. Fly-by-wire elevators 332a and 332b are connected to and in data communication with the first and second FCCs 316 and 318, and are operable using pitch servo 330 in response to a signal from the operator inputs and/or force sensors 306 via the FCCs to vary the pitch of the aircraft. Similar to the manual ailerons 326a and 326b, the manual elevators 334a and 334b may be selectively operable by an autopilot servo 312 which may command these control surfaces when autopilot is engaged. Some embodiments may also include an optional trim tab 336 disposed on at least one of the elevators 334a and 334b.

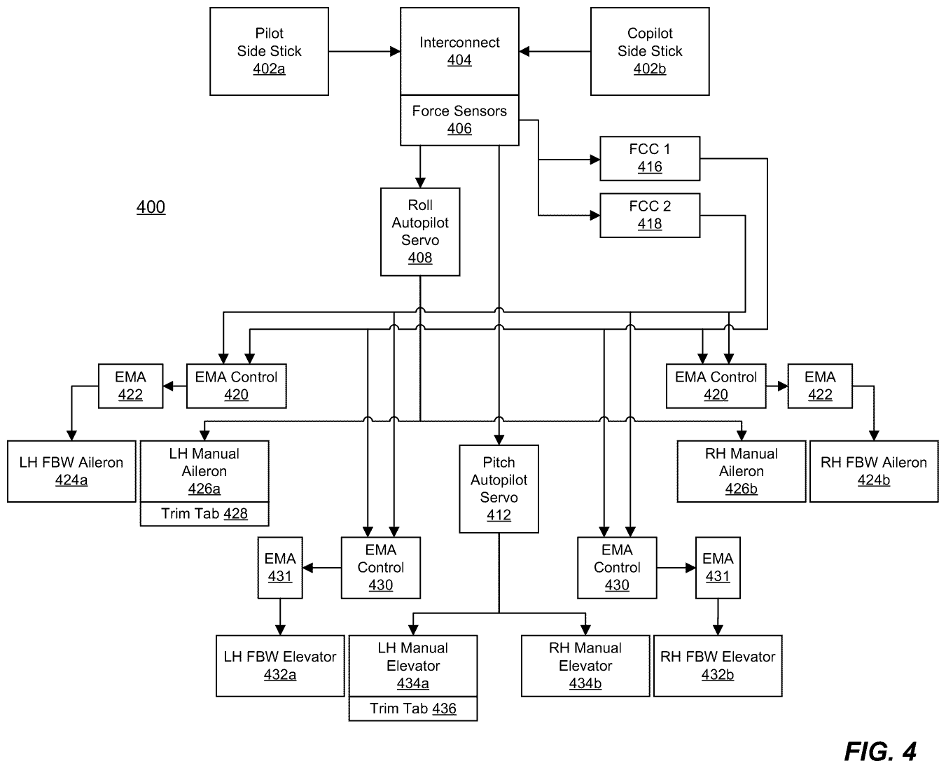

FIG. 4 shows another embodiment of a hybrid flight control system 400, which is similar to flight control system 300. For brevity and convenience, reference numbers 400-499, referring to the embodiment shown in FIG. 4, correspond generally to reference numbers 300-399. For example, left-hand and right-hand mechanical ailerons and/or roll spoilers 426a and 426b correspond to left-hand and right-hand mechanical ailerons 326a and 326b, pilot side stick 402a corresponds to pilot side stick 402a, etc., except where shown, described, or otherwise inherent.

Compared to hybrid flight control system 300, the fly-by-wire control surfaces of at least one control axis are not commanded by a servo motor, but rather an EMA and EMA controller. In the example shown, both the pitch and roll axes use EMAs 431 and 422, respectively; however, in other embodiments one axis may utilize EMAs and the other may utilize servo controls similar to flight control system 300. In the illustrated embodiment, to activate the ailerons 424a and 424b, at least one of, and preferably both FCCs 416 and 418 send a signal to EMA controllers 420 in response to an input from the pilot or copilot, and EMA controllers 420 command the EMAs 422 which then operate the control surfaces accordingly. The elevators 432a and 432b operate similarly to ailerons 424a and 424b, each being controlled by an EMA controller 430 which is in data communication with at least one and preferably both FCCs 416 and 418.

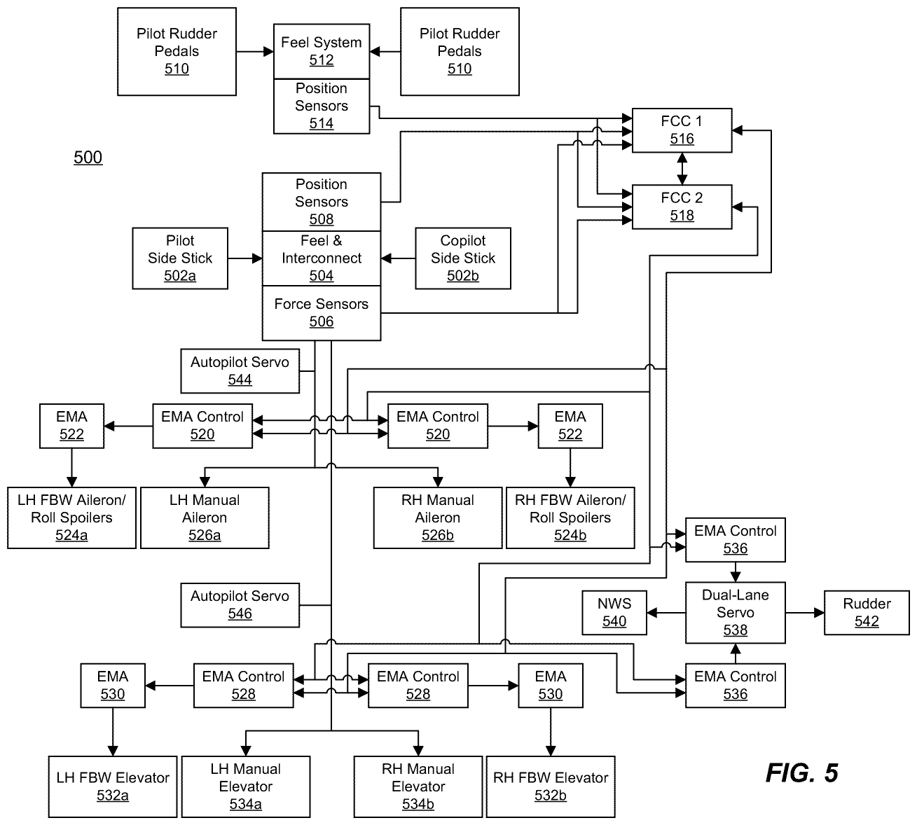

FIG. 5 shows another embodiment of a hybrid flight control system 500. The flight control system 500 comprises a plurality of control surfaces. Similar to flight control system 400, in some embodiments, these control surfaces—such as ailerons, roll spoilers, elevators, rudders, etc.—may include split surfaces, whereby some portions of the control surface are mechanically-controlled, and other portions of the control surface are controlled using fly-by-wire systems. Each control surface may be controlled (mechanically or using FBW) by one or more operator inputs, such as side sticks 502a and 502b, or rudder pedals 510.

Pilot and copilot side sticks 502a and 502b, respectively, may be connected via an interconnect system 504. The inputs 502a and 502b are also connected to or include a force sensor 506, which measures the operator's applied effort to the inputs, as well as a position sensor 508, which measures the current position (which may be an angular position) of the operator inputs. The inputs are connected to a portion of the control surfaces via one or more mechanical linkages, which respond directly to the operator's physical inputs and can provide natural feedback. The interconnect system 504 may be configured to provide feedback to the operator and improve the overall feel of the controls. For example, in some embodiments, this interconnect system 504 may be configured to provide a centering force to the side sticks 502a and 502b in the event of a mechanical path disconnect in the flight control system, whereby only the FBW path is operational. This may replicate the feel of purely mechanical controls, thereby providing the desired feedback to the operator.

Each of the embodiments shown in FIGS. 1-4 may utilize conventional (i.e., purely mechanical) rudder control systems controlled by an operator through rudder pedals. In the embodiments shown in FIGS. 5-7, the rudder pedals, such as rudder pedals 510, like the side sticks 502a and 502b, may be configured to operate both mechanical control surfaces and FBW control surfaces. In some embodiments, the rudder pedals 510 may solely operate mechanical control surfaces, while in other embodiments these pedals 510 may operate solely using FBW. Rudder pedals 510 may also be connected and coupled to a system 512 which provides “artificial” feedback to the operators that replicates the feeling of purely mechanical controls when using FBW implementations. The pedals 510 are also connected to a position sensor 514 which is similar to position sensor 508 in function.

As noted above, many of the key control surfaces may be split into portions which are mechanically controlled and portions which are controlled using FBW systems. In the illustrated embodiment, side sticks 502a and 502b are operatively connected via mechanical linkages to left-hand and right-hand mechanical ailerons 526a and 526b, respectively, for controlling the roll of the aircraft. Similarly, the side sticks 502a and 502b are also connected via mechanical linkages to left-hand and right-hand mechanical elevators 534a and 534b, respectively, for controlling the pitch of the aircraft. The mechanical linkages between the operator inputs and the control surfaces may, in some embodiments, each be connected to and operable by an autopilot servo, such as autopilot servos 544 and/or 546.

The force sensors 506, position sensors 508, and position sensors 514 are each in communication with at least one flight control computing system 516. Preferably, there is at least a second flight control computing system 518 which is also in communication with each of the aforementioned sensors, which can provide redundancy in the event of malfunction of any of the connected elements or the computer itself. One of skill in the art will appreciate that any number of sensors or computers may be employed as a backup or for additional data without departing from the scope of the invention.

In addition to the mechanical control surfaces, the operator inputs such as side sticks 502a, 502b, and 510 are connected to various FBW control surfaces. Upon receiving an input from a user to one of the control means, the position sensors and/or the force sensors send a signal to one or more flight control computers 516 and 518. For example, force sensors 506 and position sensors 508 send a signal to the flight control computers 516 and 518, respectively, which corresponds to changing the roll of the aircraft. These signals may contain force or position data indicating the input by the operator on the side sticks. The computers 516 and 518 are then in communication with roll EMA controllers 520, and each computer sends a signal to each roll EMA controller 520. Upon receiving these signals, each roll EMA controller 520 may then output an actuator command signal to one or more roll EMAs 522, which moves at least one of the left-hand and right-hand ailerons 524a and 524b, respectively, to a desired position in order achieve the desired flight conditions. The desired position of the control surfaces may depend on a number of predetermined conditions, or a predetermined schedule which is based on a number of factors, including, but not limited to, the measured input force from the operator, the aircraft's normal acceleration, airspeed, and altitude.

Similarly, force sensors 506 and position sensors 508 may send a signal to the flight control computers 516 and 518 which indicate a desire to alter the pitch of the aircraft. The computers 516 and 518 may therefore also be in communication with pitch EMA controllers 528, wherein each computer sends a signal to each pitch EMA controller 528. Upon receiving a signal, each pitch EMA controller 528 may then output an actuator command signal to one or more pitch EMAs 530, which moves at least one of the left-hand and right-hand elevators 532a and 532b, respectively, to a desired position in order to achieve the desired flight control response.

In some embodiments, the fly-by-wire control system may also include controls for the yaw of the aircraft, such as the rudder. Similar to the side sticks described above, the rudder pedals 510 are connected to position sensors 514, as well as an integrated system 512 for providing artificial feedback to the operators. Similar to the FBW pitch and roll system, the position sensor 514 is in data communication with the flight control computers 516 and 518, and sends a position signal to the computer(s). The computers 516 and 518 may then send a signal to one or more yaw EMA controllers 536, which are connected to an EMA or a dual-lane servo 538. This dual-lane servo 538 may then, via a mechanical linkage, change the position of the rudder 542 in order to achieve the desired flight characteristics, as well as engage with the nose wheel steering assembly 540 if desired.

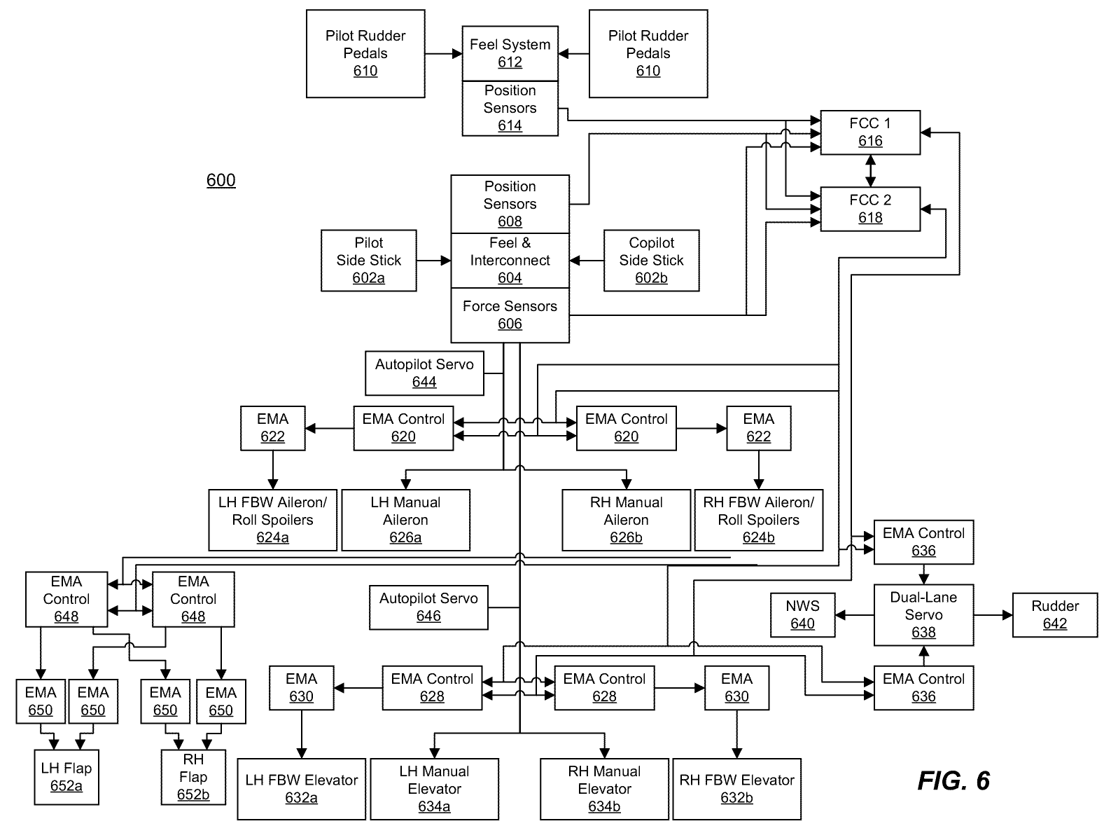

Referring now to FIG. 6, yet another embodiment of a hybrid flight control system 400 is shown. The hybrid flight control system 600 is similar to hybrid flight control system 300 as described above. For brevity and convenience, reference numbers 600-699, referring to the embodiment shown in FIG. 6, correspond generally to reference numbers 500-599. For example, left-hand and right-hand mechanical ailerons and/or roll spoilers 626a and 626b correspond to left-hand and right-hand mechanical ailerons 526a and 526b, pilot rudder pedals 610 correspond to pilot rudder pedals 510, etc., except where shown, described, or otherwise inherent.

Compared to hybrid flight control system 500, hybrid flight control system 600 further employs FBW systems for control of the aircraft's flaps. Similar to the roll and pitch FBW control systems, the flap control systems require signals sent from the operator input(s) 602a and 602b to a computing system, which sends a signal to one or more EMA controllers 648. The EMA controllers 648 then send a signal to an EMA 650, which adjusts the left-hand flap 652a and/or the right hand flap 652b to achieve the desired flight characteristics.

In the embodiments shown in FIGS. 5 and 6, during normal operation the force required by the operator to achieve certain flight characteristics is reduced by the use of the FBW control surfaces in parallel with traditional mechanical controls. Because only a portion of the control surfaces are mechanically controlled, rather than the whole surface, the operator may only require a portion of the input force that would otherwise be required to achieve the same flight characteristics if the surfaces were entirely mechanically-controlled. Likewise, because a portion of the control surfaces remain mechanically-operated rather than completely fly-by-wire, the operator may still receive traditional “natural” feedback through the inputs.

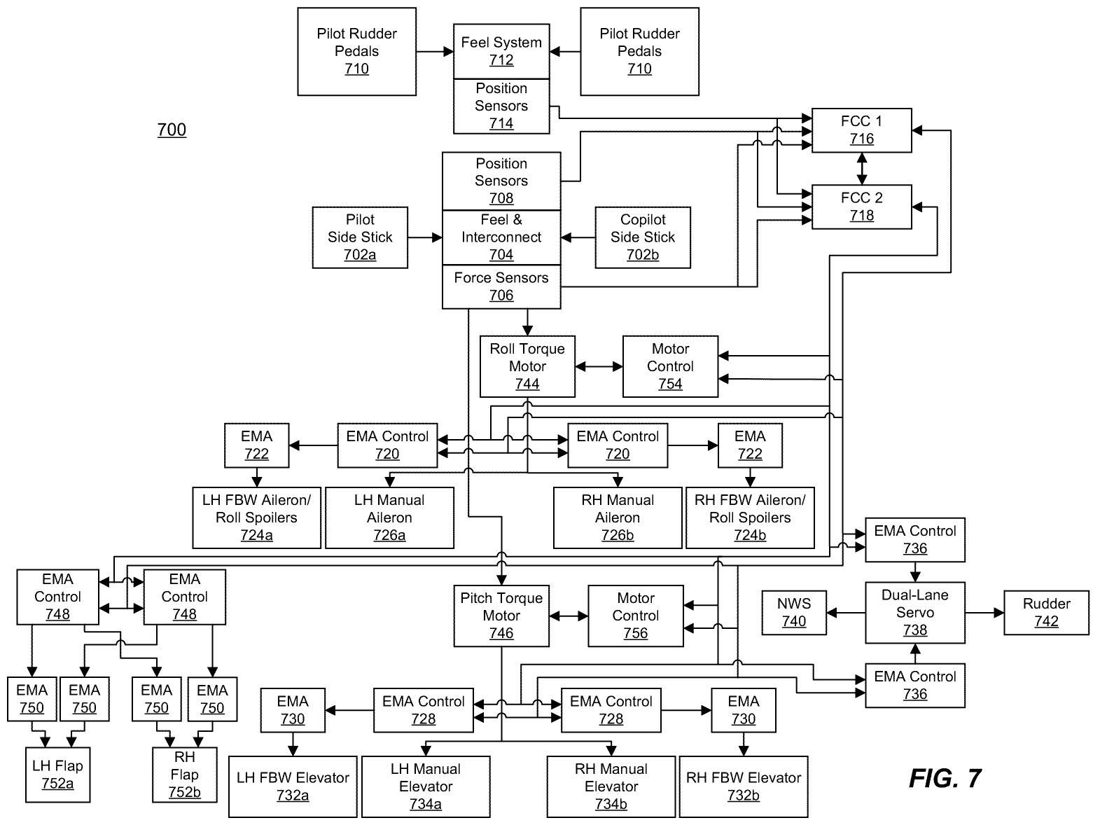

FIG. 7 shows another embodiment of a hybrid flight control system, which is similar to the flight control system 600 described above, except where otherwise noted. For brevity and convenience, reference numbers 700-799, referring to the embodiment shown in FIG. 7, correspond generally to reference numbers 600-699, except where otherwise shown or inherent.

Similar to the embodiment shown in FIG. 2, the flight control system 700 includes a roll torque motor 744 and a pitch torque motor 746 as part of the system which operates the mechanically-controlled portion of the control surfaces. The roll torque motor 744 is connected to a torque motor controller 754, which is in communication with the flight control computers 716 and 718. The roll torque motor is configured to reduce the moment at the control surface hinges, thereby reducing the necessary input force required from the pilot. The roll torque motor therefore provides a mechanical “boost” when the pilot or copilot engages the mechanical ailerons 726a and 726b.

Likewise, the pitch torque motor 746 is connected to a torque motor controller 756, which is in communication with the flight control computers 716 and 718. The pitch torque motor is similarly configured to reduce the moment at the control surface hinges, thereby reducing the necessary input force required from the pilot to achieve a desired flight characteristic. The pitch torque motor therefore provides a mechanical “boost” when the pilot or copilot engages the mechanical elevators 732a and 732b.

During normal operation, the roll and pitch torque motors provide an additional “boost” to the mechanically-operated control surfaces, while the flight control system 700 also includes the various FBW-operated control surfaces which use EMAs as described previously. In the event of a failure in the torque motors, the operator may still maintain control using the traditional mechanical system (without the “boost”) and the FBW augmentation; similar to the embodiment shown in FIG. 6. Similarly, a failure in the FBW system may result in boosted mechanical control, or boosted mechanical control with at least a partial FBW augmentation, depending on the nature of the failure.

Although the invention has been described with reference to the embodiments shown in the attached drawing figures, it is noted that the equivalents may be employed and substitutions made herein without departing from the scope of the invention as recited in the claims.

Having thus described various embodiments of the invention, what is claimed as new and desired to be protected by Letters Patent includes the following:

1. A hybrid flight control system for an aircraft having a control surface, the system comprising:
an operator input device having a sensor, the operator input device being connected to a first portion of the control surface via a mechanical linkage;
an electro-mechanical actuator;
an electro-mechanical actuator control system in data communication with the electro-mechanical actuator; and
a flight control computing system in data communication with the operator input and the electro-mechanical actuator control system;
wherein:
upon receiving an input from an operator, the operator input device sends a signal to the flight control computing system;
upon receiving a signal from the operator inputs, the flight control computing system sends a signal to the electro-mechanical actuator control system; and
upon receiving a signal from the electro-mechanical actuator control system, the electro-mechanical actuator moves a second portion of the control surface according to a predetermined set of conditions.

2. The hybrid flight control system of claim 1, further comprising an air data computing system configured to obtain air data, and wherein the predetermined set of conditions are determined using the air data.

3. The hybrid flight control system of claim 1, further comprising a second electro-mechanical actuator in data communication with the electro-mechanical actuator control system, the second electro-mechanical actuator being configured to move the second portion of the control surface.

4. The hybrid flight control system of claim 1, wherein the mechanical linkage includes an autopilot servo.

5. The hybrid flight control system of claim 1, wherein the control surface is a first control surface configured to control the aircraft about a first axis, and the system comprises a second control surface configured to control the aircraft about a second axis, the second control surface having a first portion connected to the operator input via a mechanical linkage and a second portion moveable by a second electro-mechanical actuator.

6. The hybrid flight control system of claim 1, further comprising a second flight control computing system in data communication with the operator input and the electro-mechanical actuator control system.

7. A hybrid flight control system for an aircraft having a control surface, the system comprising:
an operator input device connected to a first portion of the control surface via a mechanical linkage;
an electro-mechanical actuator connected to a second portion of the control surface;
an electro-mechanical actuator control system in data communication with the electro-mechanical actuator; and
an air data computing system in data communication with the electro-mechanical actuator control system;
wherein:
the air data computing system sends a signal to the electro-mechanical actuator control system; and
upon receiving a signal from the electro-mechanical actuator control system, the electro-mechanical actuator adjusts a force reversing system to reduce the surface force reacted to the operator according to a predetermined set of conditions.

8. The hybrid flight control system of claim 7, further comprising a second air data computing system in communication with the electro-mechanical actuator control system, wherein the predetermined set of conditions is based at least partially on air data collected by at least one of the air data computing systems.

9. The hybrid flight control system of claim 7, wherein the mechanical linkage includes at least one of a servo and a torque motor.

10. The hybrid flight control system of claim 7, further comprising a flight control computing system comprising a plurality of flight control computers, the flight control computing system being connected to and in data communication with the electro-mechanical actuator control system.

11. The hybrid flight control system of claim 7, further comprising a second electro-mechanical actuator in communication with the electro-mechanical actuator control system and connected to the second portion of the control surface.

12. The hybrid flight control system of claim 10, wherein the second portion of the control surface is connected to the operator input by a mechanical linkage, and a failure in at least one of: the electro-mechanical actuator, the electro-mechanical actuator control system, and the flight control computing system permits mechanical operation of the second portion of the control surface by the mechanical linkage in response to an operator input.

13. A hybrid flight control system for an aircraft having a plurality of control surfaces, the system comprising:
an operator input means configured to receive mechanical inputs from an aircraft operator, the operator input means being connected to a sensor;
a flight control computing system comprising a first and a second flight control computer, each flight control computer being in data communication with the sensor,
wherein the computing system receives a signal from at least one sensor in response to an input by the operator;
a first control surface for controlling a first axis of the aircraft, the first control surface having a first portion connected to the operator input via a mechanical linkage and a second portion connected to and moveable by at least one EMA in data communication with a first EMA controller configured to receive signals from the flight control computing system; and
a second control surface for controlling a second axis of the aircraft, the second control surface having a first portion connected to the operator input via a mechanical linkage and a second portion connected to and moveable by at least one EMA in data communication with a second EMA controller configured to receive signals from the flight control computing system.

14. The flight control system of claim 13, further comprising:
a second operator input means connected to an artificial feel system and a sensor, the sensor being in communication with the flight control computing system; and
a third control surface for controlling a third axis of the aircraft, the third control surface being operable in response to an input via the second operator input means.

15. The flight control system of claim 14, wherein the third control surface is connected to and moveable by at least one EMA in data communication with a third EMA controller configured to receive signals from the flight control computing system.

16. The flight control system of claim 15, wherein the at least one EMA connected to the third control surface is a dual-lane servo which is connected to and in data communication with a nose wheel steering assembly.

17. The flight control system of claim 13, wherein the mechanical linkage connecting the first portion of the first control surface to the operator input includes an autopilot servo.

18. The flight control system of claim 17, wherein the mechanical linkage connecting the first portion of the second control surface to the operator input includes an autopilot servo.

19. The flight control system of claim 13, further comprising a third control surface, the third control surface being configured to control the first axis of the aircraft and being connected to at least one EMA in data communication with a third EMA controller configured to receive signals from the flight control computing system.

20. The flight control system of claim 19, wherein the at least one EMA in data communication with the third EMA controller is in data communication with a fourth EMA controller configured to receive signals from the flight control computing system.
